(19) United States
(12) Patent Application Publication
(10) Pub. No.: US 2008/0270236 A1
(43) Pub. Date: Oct. 30, 2008

(54) Systems and methods for digital content promotion

(76) Inventors: Kevin Arnold, San Francisco, CA (US); Tim Mitchell, San Francisco, CA (US); Michael Drake, San Francisco, CA (US); Adam Rabinovitz, San Francisco, CA (US); Mia Steinberg, San Francisco, CA (US); Rishi Satsangi, San Francisco, CA (US); Marisol Segal, San Francisco, CA (US); Corey Denis, San Francisco, CA (US); David Schlossberg, San Francisco, CA (US); Fayvor Love, San Francisco, CA (US)

Correspondence Address: CARR & FERRELL LLP, 2200 GENG ROAD, PALO ALTO, CA, 94303, US

(21) Appl. No.: 12/002,788

(22) Filed: Dec. 17, 2007

Related U.S. Application Data
(60) Provisional application No. 60/875,280, filed on Dec. 15, 2006.

(51) Int. Cl. G06Q 30/00

(52) U.S. Cl. 705/14

(57) ABSTRACT

Exemplary systems and methods are provided for digital content promotion. Such methods may include storing an item of digital content received from a rightsholder, receiving data from the rightsholder about the item of digital content, and offering the item of digital content to a second party, such as a blogger or podcaster. A request is received from the second party for the item of digital content and the item of digital content is provided to the second party. Further methods may include reporting to the rightsholder the request received from the second party and the providing of the item of digital content to the second party. Additionally, a purchase link may be provided to the second party for purchase of a related item of digital content. Exemplary systems may include a digital content storage component configured to store an item of digital content received from a rightsholder, a rightsholder data component configured to receive data from the rightsholder about the item of digital content, and a presentation engine which is configured to offer the item of digital content to a second party. A transmission module coupled to the presentation engine receives a request from the second party for the item of digital content and provides the item of digital content to the second party. Further systems may include a reporting module configured to report to the rightsholder the request received from the second party.

### CROSS-REFERENCE TO RELATED APPLICATIONS

The present application claims the benefit and priority of U.S. Provisional Patent Application Ser. No. 60/875,280 filed on Dec. 15, 2006 for “Systems and Methods for Distribution of Digitalized Multimedia,” which is incorporated herein by reference.

### FIELD OF THE INVENTION

The present invention relates generally to digital content, and more particularly to systems and methods for digital content promotion.

### DESCRIPTION OF RELATED ART

Conventionally, when a musical artist wishes to promote their recorded work to the public, they must partner with a company that can manufacture, distribute and promote their recorded work on a mass scale basis. These companies are often referred to as “record labels,” and tend to generate a great deal of publicity about the musical artists they sponsor, as well as to sell the recorded works of their sponsored artists in a large number of retail outlets located throughout the world. The record labels generally have business relationships with the movie studios, radio stations, television networks and/or major concert venues and therefore have the capability to make someone who was previously unknown into a major superstar within a short time frame. This approach, however, suffers from several drawbacks. Many highly talented musical artists outside of the mainstream popular music “Top 40” segment go unnoticed because they can not find a record label to promote their recorded works. Thus, they lack access to the movie studios, radio stations, television networks and/or major concert venues. Retail outlets have limited shelf space and can only sell the recorded works of the most popular musical artists. Record labels and distributors are generally paid a major share of the revenue generated by the sale of recorded works, leaving little money or incentive for the musical artists. Additionally, the listening tastes and needs of consumers are growing increasingly diverse, resulting in numerous niche markets that can not be satisfied by the conventional business model. Consequently, there is a need for systems and methods for digital content promotion.

### BRIEF DESCRIPTION OF THE DRAWINGS

FIG. 1 is a block diagram of an exemplary architecture for a digital content promotion system;

FIG. 2 is a screenshot of an exemplary rightsholder data entry screen;

FIG. 3 is a screenshot of an exemplary rightsholder blog and podcast targeting screen;

FIG. 4 is a screenshot of an exemplary rightsholder blog and podcast message screen;

FIG. 5 is a screenshot of an exemplary blog and podcast offering screen;

FIG. 6 is a screenshot of an exemplary blog set-up screen;

FIG. 7 is a screenshot of an exemplary blog;

FIG. 8 is a screenshot of an exemplary podcast reporting screen;

FIG. 9 is a screenshot of an exemplary podcast detail reporting screen;

FIG. 10 is a screenshot of an exemplary rightsholder report; and

FIG. 11 is flow chart of an exemplary method for digital content promotion.

### SUMMARY OF THE INVENTION

Exemplary methods are provided for digital content promotion. Such methods include storing an item of digital content received from a rightsholder, receiving data from the rightsholder about the item of digital content, and offering the item of digital content to a second party, such as a blogger or podcaster. When a request is received from the second party for the item of digital content, the item of digital content is provided to the second party. Further methods may include reporting to the rightsholder the request received from the second party and reporting to the rightsholder the providing of the item of digital content to the second party. Additionally, a purchase link may be provided to the second party for purchase of a related item of digital content.

Exemplary systems are also provided for digital content promotion. Such systems may include a digital content storage component configured to store an item of digital content received from a rightsholder, a rightsholder data component configured to receive data from the rightsholder about the item of digital content, and a presentation engine which is configured to offer the item of digital content to a second party. A transmission module receives a request from the second party for the item of digital content and provides the item of digital content to the second party. Further systems may include a reporting module configured to report to the rightsholder the request received from the second party.

### DETAILED DESCRIPTION

Exemplary systems and methods are provided for digital content promotion. Digital content such as a musical track is received from a rightsholder, along with data about the item of digital content. The item of digital content is offered and provided to a second party, such as a blogger or podcaster, who promotes the item of digital content to an audience. A purchase link to a party such as an online retailer may also be provided to the second party, so their audience may purchase related items of digital content. Actions such as the uploading or downloading of digital content by the bloggers, podcasters and/or their respective audiences, as well as other activities, such as clicks upon the purchase links, may be reported to the rightsholders.

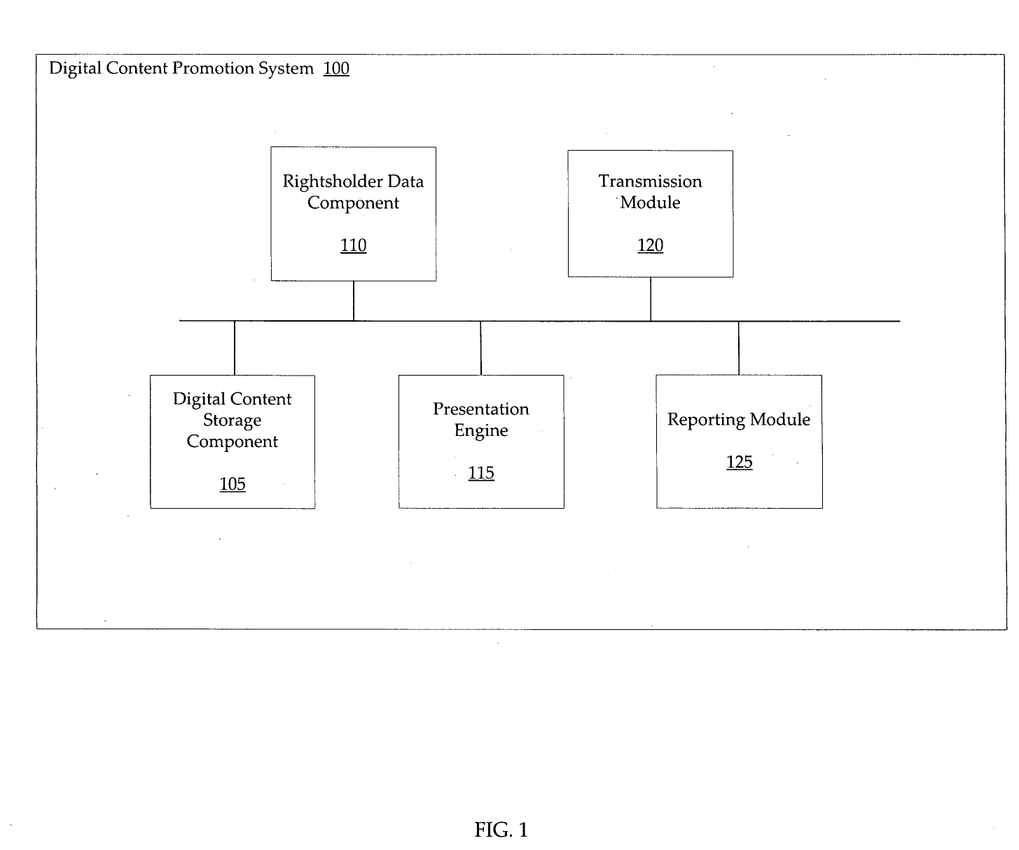

FIG. 1 is a block diagram of an exemplary architecture for a digital content promotion system. The exemplary digital content promotion system 100 includes a digital content storage component 105, a rightsholder data component 110, a presentation engine 115, a transmission module 120, and a reporting module 125.

According to one exemplary embodiment, the digital content storage component 105 may include one or more servers configured to store items of digital content received from rightsholders. A rightsholder is a person and/or entity that owns the copyrights and/or publishing rights to items of digital content, or may be authorized by the owner or owners of the copyrights and/or publishing rights to promote the items of digital content. In addition to musical tracks, digital content may include audio, visual, audiovisual, image-based, and/or photographic material or any combination or permutation thereof, including the associated metadata. The items of digital content may be downloaded by the rightsholder and/or may be provided to a system administrator for uploading and storing within the digital content storage component 105.

A rightsholder data component 110, according to one embodiment of the digital content promotion system 100, is coupled to the digital content storage component 105. The rightsholder data component 110 is configured to receive data from the rightsholder about the item of digital content. Such data may include whether a particular track is available for sale as part of an album, whether the rightsholder owns the publishing rights, and/or other information about the track as will be further described herein.

According to one embodiment, a presentation engine 115 may be coupled to both the digital content storage component 105 and to the rightsholder data component 110. The presentation engine 115 may be configured to present or offer an item of digital content to a second party, such as a podcaster or blogger. The podcaster or blogger may wish to comment upon, publicize and/or promote the item of digital content to those who view their blog or listen to their podcast. Such a presentation may include some or all of the data received from the rightsholder about the item of digital content, as contained in the rightsholder data component 110.

In one exemplary embodiment, a transmission module 120 may be coupled to the presentation engine 115 in order to receive a request from a second party for an item of digital content. The transmission module 120 may provide to the second party the requested item of digital content or may provide a link to the item of digital content. The transmission module 120 may provide a purchase link to the second party for purchase of a related item of digital content. For example, someone reading a blog about a particular musical track may wish to click on the purchase link to be directed to an online music retailer. A related item of digital content may be a second track of digital content by the same artist or musical artist, group, label and/or a full release or album by the same artist or musical artist, group and/or label.

According to one embodiment, a reporting module 125 is in communication with the transmission module 120 and may report to the rightsholder a request received from a second party for an item of digital content. The reporting module 125 may report to the rightsholder the transmission of an item of digital content to the second party. The reporting module may report to the rightsholder each upload or download of an item of digital content by a third party interacting with the second party. For example, the reporting module may report to the rightsholder that someone downloaded a copy of a musical track from a blogger's web site. The reporting module may report to the rightsholder when a purchase link is clicked on. In a further embodiment, the reporting module may report to the rightsholder sales activity with respect to a particular item of digital content. It will be appreciated that multiple varieties of reports may be generated and remain within the scope of contemplated embodiments.

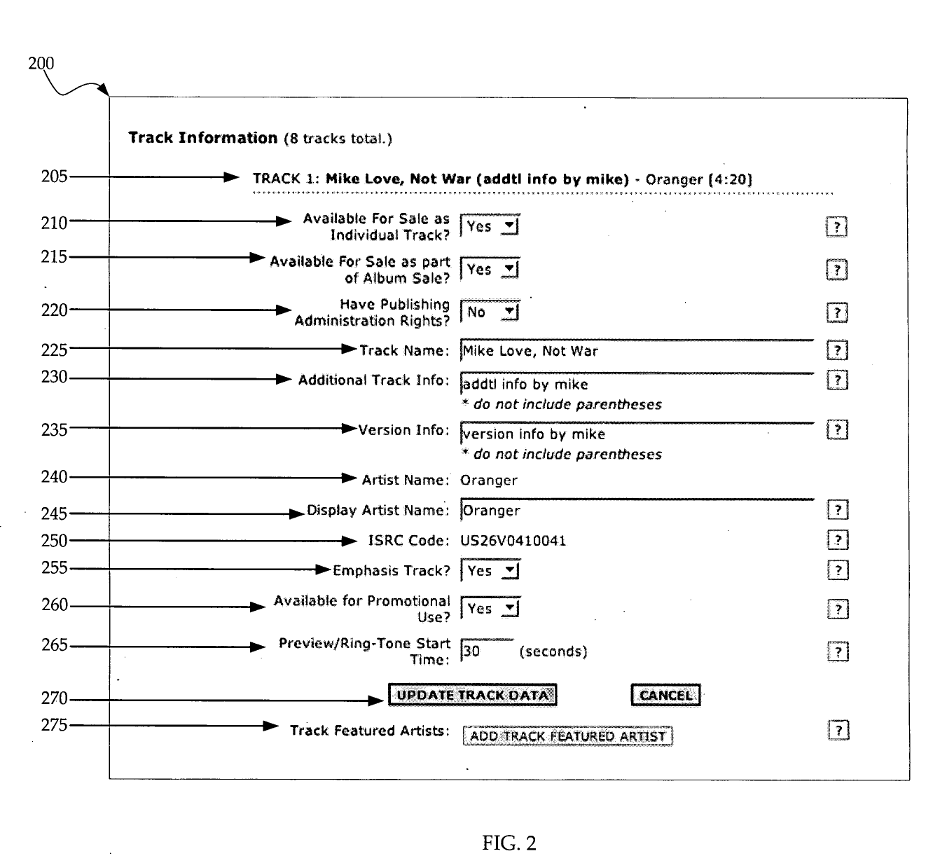

FIG. 2 is a screenshot of an exemplary rightsholder data entry screen. The exemplary rightsholder data entry screen 200 may include a track number field 205, a track sale availability field 210, an album sale availability field 215, a publishing rights field 220, a track name field 225, an additional track information field 230, a version information field 235, an artist name field 240, a display artist name field 245, an International Standard Recording Code (“ISRC”) field 250, an emphasis track identification field 255, a promotional availability field 260, a ring tone information field 265, an update track data command 270, and a track featured artist information command 275.

According to one exemplary embodiment, a rightsholder may enter some or all of the information in the exemplary rightsholder data entry screen 200. For example, a rightsholder may utilize the rightsholder data entry screen 200 to enter or otherwise indicate a track number, as shown by the entry of “TRACK 1” within the track number field 205. The rightsholder may indicate whether a particular track is available for sale as an individual track, as shown by the entry of “Yes” within the track sale availability field 210. The rightsholder may indicate whether the particular track is available for sale as part of an album, as shown by the entry of “Yes” within the album sale availability field 215.

Additionally, the rightsholder may indicate whether they own the publishing rights for a particular track, as shown by the entry of “No” within the publishing rights field 220. The rightsholder may enter a track name, such as “Mike Love, Not War” as entered in track name field 225. The rightsholder may enter additional track information such as “addtl info by mike” as entered in additional track information field 230. The rightsholder may enter version information such as “version info by mike” as entered in the version info field 235. In a similar fashion, the rightsholder may enter an artist name such as “Oranger” as entered in artist name field 240, and the rightsholder may enter or select a display artist name such as “Oranger” as entered in the display artist name field 245. The rightsholder may enter or select an ISRC code such as “US26V0410041” as entered in the ISRC code field 250. The rightsholder may enter whether a particular track is an emphasis track, by indicating “Yes” as entered in the emphasis track field 255. The rightsholder may enter whether a particular track is available for promotional use, by indicating “Yes” in the promotional availability field 260. The rightsholder may enter or select ring tone information such as “30” seconds as entered in the ring tone information field 265. The rightsholder may elect to update the track data by clicking or otherwise activating the update track data command 270. The rightsholder may also elect to add another track by activating the add track featured artist information command 275. It should be noted that a rightsholder data entry screen may include information other than the information shown in the exemplary rightsholder data entry screen 200 and remain within the scope of the embodiments contemplated herein.

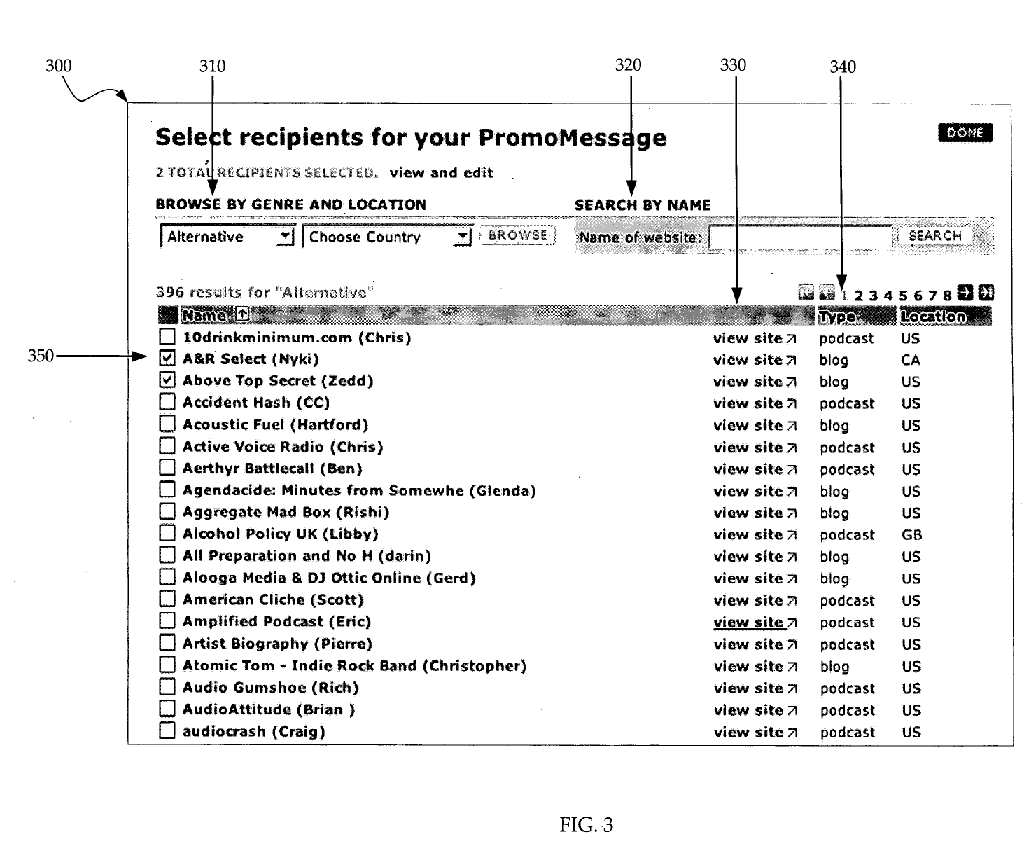

FIG. 3 is a screenshot of an exemplary rightsholder blog and podcast targeting screen. The exemplary rightsholder blog and podcast targeting screen 300 includes a genre and location selection 310, a web site name search 320, a web site viewing command 330, a promotion type identification 340, and a site selection 350.

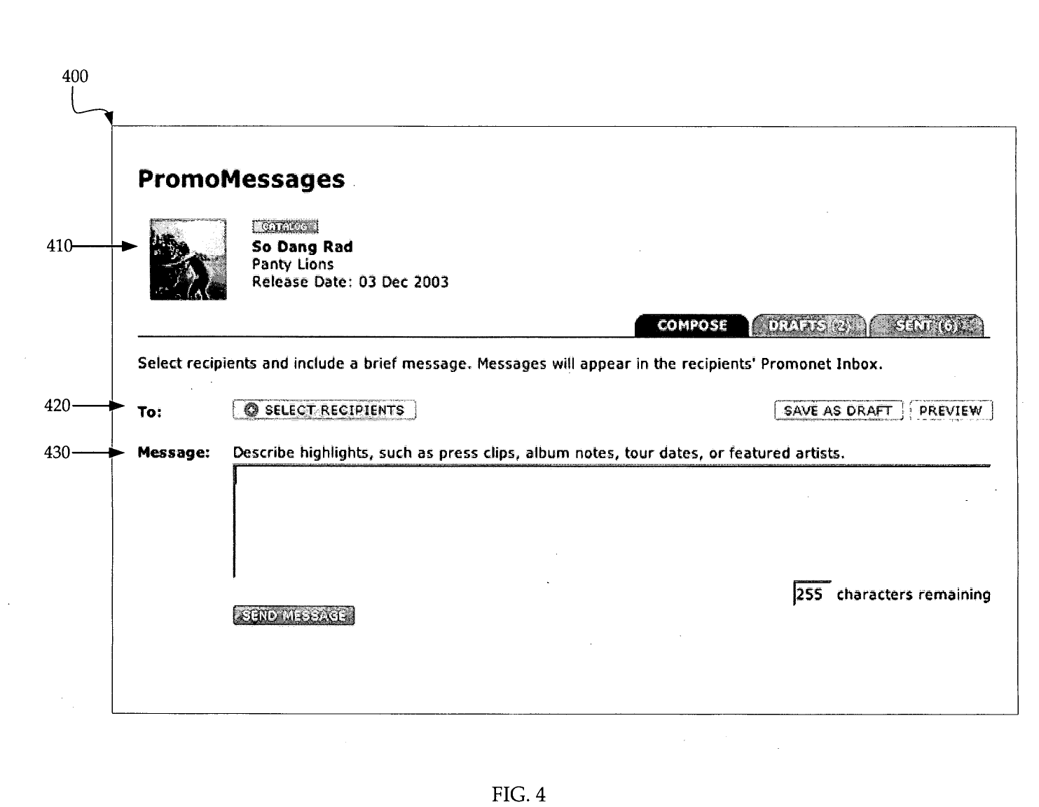

According to one exemplary embodiment, after a rightsholder has uploaded their digital content to the system, such as the exemplary digital content promotion system 100 (FIG. 1), and after the rightsholder has entered information in a rightsholder data entry screen, such as the exemplary rightsholder data entry screen 200 (FIG. 2), the rightsholder may use the exemplary rightsholder blog and podcast targeting screen 300 to target the particular promotional services such as podcasters and bloggers to be offered the rightsholder's digital content. For example, a rightsholder may use the genre and location selection 310 to find those promotional services within the United States of America that focus on promoting Rock and Roll music. Alternatively, the rightsholder may use the web site name search 320 to find a particular promotional service by name. After finding a particular promotional service or services, the rightsholder may use the web site viewing command 330 to access and view a particular promotional service. The promotion type identification 340 indicates to the rightsholder if a particular promotional service is a blogger or podcaster. There may be other types of promotional services that may be indicated to the rightsholder. The rightsholder may use the site selection 350 to indicate one or more sites to receive a message from the rightsholder as will be described in connection with FIG. 4 herein.

FIG. 4 is a screenshot of an exemplary rightsholder blog and podcast message screen. The exemplary rightsholder blog and podcast message screen 400 includes digital content 410, message recipients 420 and message 430.

According to one exemplary embodiment, after a rightsholder used the site selection 350 (FIG. 3) to indicate one or more sites to receive a message from the rightsholder, the rightsholder may be directed to the exemplary blog and podcast message screen 400. The exemplary blog and podcast message screen 400 may be automatically formatted with one or more items of digital content 410 associated with the rightsholder. For example, digital content 410 may include an album cover, a promotional track and/or associated metadata. The exemplary blog and podcast message screen 400 may also be formatted with the names and/or addresses of the message recipients 420. The rightsholder may enter the message 430 that is intended for the message recipients 420. For example, the rightsholder may desire for the message 430 to include highlights about the digital content 410, such as press clips, album notes, tour dates, or featured artists.

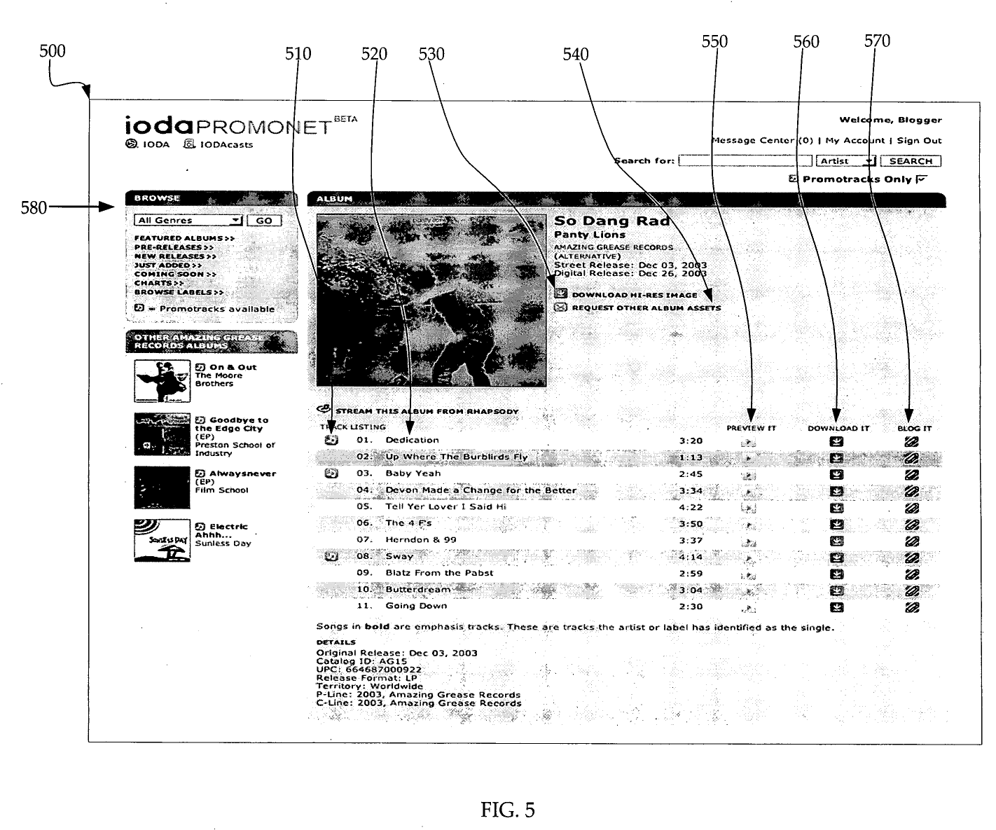

FIG. 5 is a screenshot of an exemplary blog and podcast offering screen. The exemplary blog and podcast offering screen 500 includes promotional track selection 510, track title display 520, download image selection 530, album assets request selection 540, preview selection 550, download selection 560, blog selection 570 and browse selection 580.

According to one exemplary embodiment, a blogger and/or podcaster may view the exemplary blog and podcast offering screen 500 in order to determine whether they wish to promote a particular musical artist and/or promotional tracks associated with the particular musical artist. Likewise, a blogger and/or podcaster may be directed to a screen such as the exemplary blog and podcast offering screen 500 after receiving a message such as message 430 (FIG. 4) from a rightsholder. Upon viewing the exemplary blog and podcast offering screen 500, a blogger or podcaster may be presented with one or more items of digital content appearing under the promotional track selection 510. Such tracks may have been identified by the rightsholder in connection with entering or selecting information within a rightsholder data entry screen, such as the exemplary rightsholder data entry screen 200 (FIG. 2). For example, the rightsholder may have entered that a particular track was available for promotional use by indicating “Yes” in the promotional availability field 260 (FIG. 2). Such items of digital content may be reflected under the promotional track selection 510 of the exemplary blog and podcast offering screen 500, and are available for promotional use.

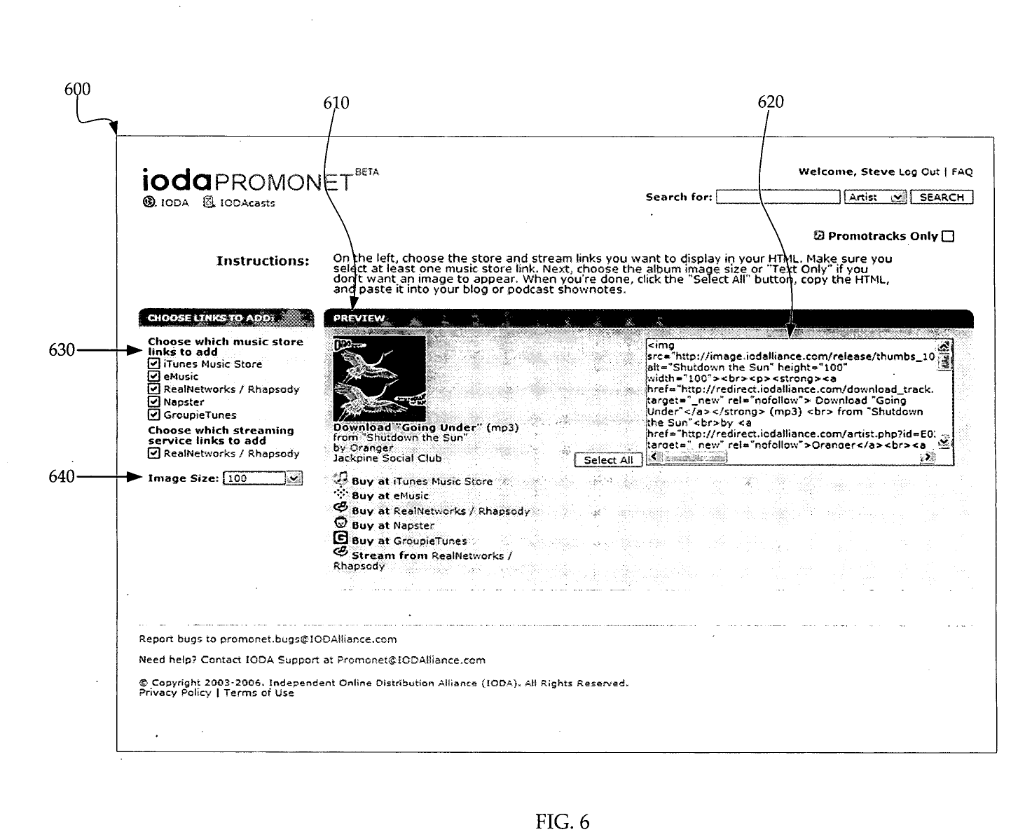

The track title display 520 shows a title for the various items of digital content (tracks). The download image selection 530 allows a blogger or podcaster to download an item of digital content such as an album cover. The album assets request selection 540, allows a blogger or podcaster to access and/or download other items of digital content or metadata associated with a particular album of digital content or tracks. For example, a blogger and/or podcaster may wish to download a copy of the lyrics to a particular track. The preview selection 550 allows a blogger or podcaster to preview or listen to some or all of a particular track. The download selection 560 may allow a blogger or podcaster to download a particular promotional track if it is so indicated under promotional track selection 510. The blog selection 570 directs a blogger and/or podcaster to a blog set-up screen as will be described further in connection with FIG. 6. The browse selection 580 allows a blogger or podcaster to search and/or locate other digital content for possible promotion.

FIG. 6 is a screenshot of an exemplary blog set-up screen. The exemplary blog set-up screen 600 includes a preview 610, Hypertext Mark-Up Language (“HTML”) 620, music store links 630, and image size 640.

In one exemplary embodiment, after a blogger or podcaster has used the blog selection 570 (FIG. 5) to automatically format and/or further customize a particular track or promotional track for use as part of a blog or podcast shownotes, they will be directed to a blog set-up screen such as the exemplary blog set-up screen 600. Within the exemplary blog set-up screen 600, the blogger or podcaster may use preview 610 to view an automatically formatted version of a digital content such as an album cover that may be carried over or otherwise replicated within the blogger's blog or the podcaster's shownotes. HTML 620 comprises the Hypertext Mark-Up Language the blogger or podcaster may copy and paste into a blog or podcast shownotes. Music store links 630 allow a blogger and/or podcaster to select one or more online retailers or distributors of digital content for which a corresponding link may be displayed on the blog or podcast shownotes. In a further embodiment, the music store links may be automatically predetermined for the blogger and/or podcaster. The links may lead someone viewing the blog and/or podcast shownotes to a destination such as a web site or computer application where the viewer may purchase related items of digital content (which may or may not include the promotional track that they might have heard while viewing the blog and/or shownotes). The image size 640 allows a blogger and/or podcaster to select an image size for such digital content as an album cover to appear on the blogger's blog or the podcaster's shownotes. Alternatively, a blogger or podcaster may select “Text Only” to appear if they do not wish for such digital content to appear.

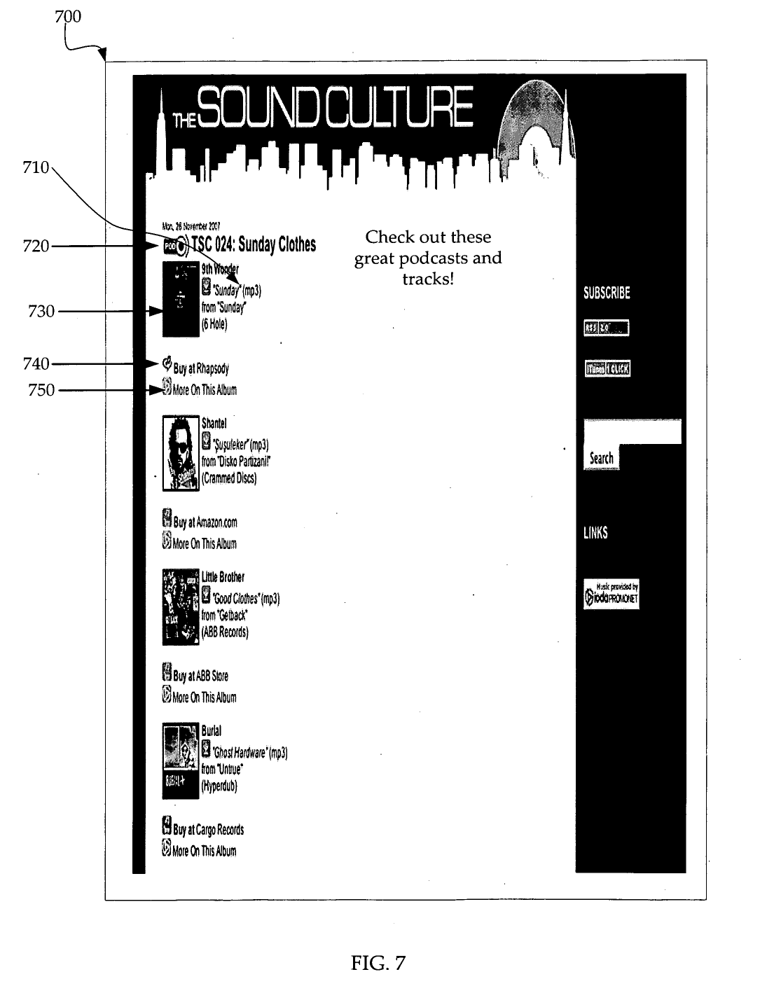

FIG. 7 is a screenshot of an exemplary blog. The exemplary blog 700 includes a track 710, a podcast 720, image 730, purchase link 740, and additional information selection 750.

According to various exemplary embodiments, after a blogger and/or podcaster has used a blog set-up screen such as the exemplary blog set-up screen 600 to establish their blog and/or podcast shownotes, a promotional blog such as the exemplary blog 700 may be created for online viewers. A viewer of the exemplary blog 700 may listen and/or download digital content such as the track 710 or the podcast 720. The viewer may wish to highlight or click on the image 730, which in the particular example shown in FIG. 7 is an album cover. The viewer may wish to highlight or click the purchase link 740 in order to be directed a web site and/or computer application where the viewer may purchase related digital content. The viewer may also wish to read more about the album by clicking or highlighting on the additional information selection 750. As will be described further herein, some or all of the viewer's actions may be reported to the rightsholder via one of any number of reporting tools.

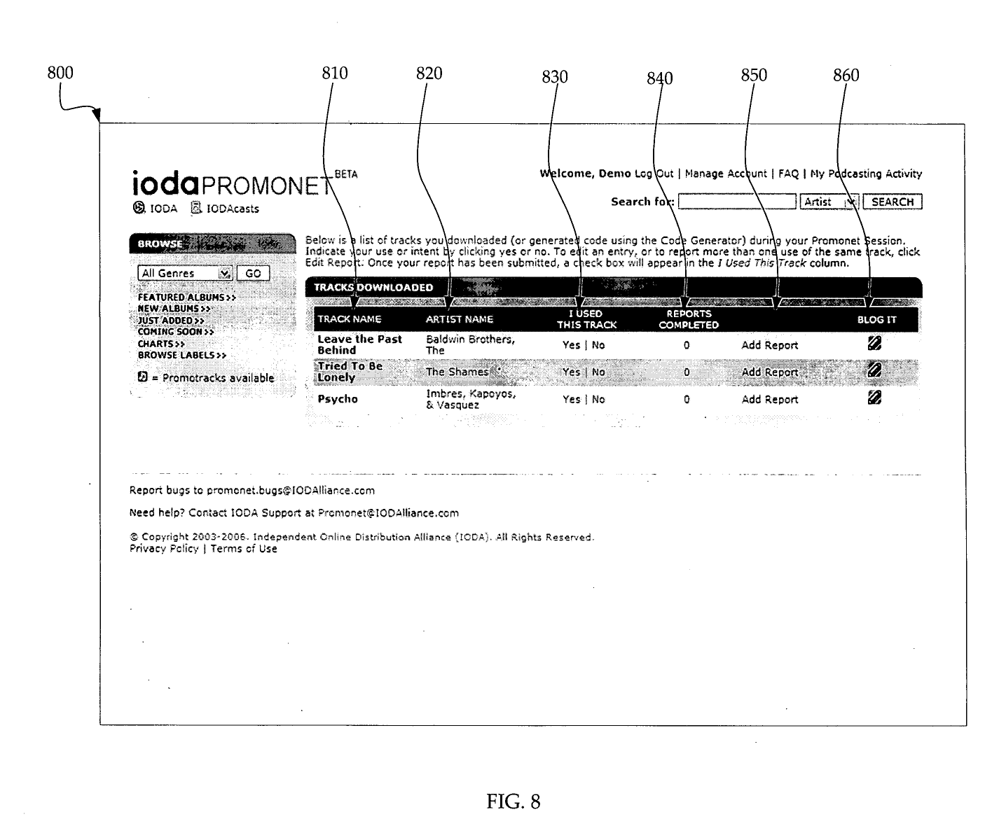

FIG. 8 is a screenshot of an exemplary podcast reporting screen. The exemplary podcast reporting screen 800 includes a track name field 810, artist name field 820, track use field 830, reports completed field 840, add report detail selection 850 and blog selection 860.

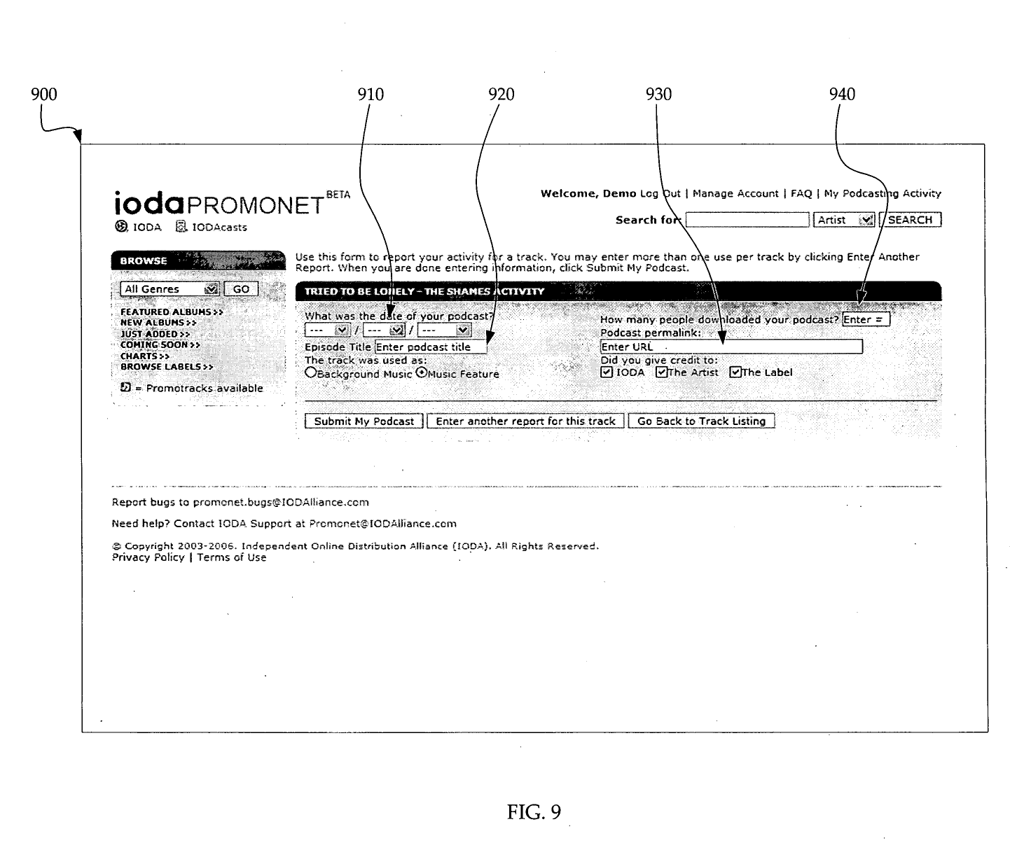

In one exemplary embodiment, a podcaster that has downloaded one or more tracks from a system such as the exemplary digital content promotion system 100 (FIG. 1), may be able to access a podcast reporting screen, such as the exemplary podcast reporting screen 800. Such a reporting screen may comprise a track name field 810 and an artist name field 820, which indicate respectively the track name and the artist name corresponding to a track that the podcaster may have downloaded from the digital content promotion system 100. Accordingly, the podcaster may use the exemplary podcast reporting screen 800 to report whether a particular track was used by the podcaster by clicking upon a link within the track use field 830. The reports completed field 840 indicates the number of reports a podcaster may have submitted to date to reflect the number of a times a particular track was used in a podcast. The podcaster may use the add report detail selection 850 to be directed to a podcast detail reporting screen as will be further described in connection with FIG. 9. Alternatively, a podcaster may use the blog selection 860 in order to be directed to a screen such as the exemplary blog set-up screen 600 (FIG. 6).

FIG. 9 is a screenshot of an exemplary podcast detail reporting screen. The exemplary podcast detail reporting screen 900 includes a field for podcast date 910, a field for podcast title 920, a field for podcast Universal Resource Locator (“URL”) 930, and a field for podcast download quantity 940.

According to one exemplary embodiment, a podcaster that has downloaded one or more tracks from a digital content promotion system such as the exemplary digital content promotion system 100 (FIG. 1) and that has utilized the track within a podcast, such as for background music or for a music feature, may be able to access a podcast detail reporting screen, such as the exemplary podcast detail reporting screen 900. Such a screen may include a field for podcast date 910, in order for the podcaster to indicate when a podcast was made and/or published. The podcast detail reporting screen 900 includes a field for podcast title 920, in order for the podcaster to enter a title for the podcast. The podcast detail reporting screen 900 includes a field for podcast URL 930, in order for the podcaster to enter the location of the podcast. The podcast detail reporting screen 900 also includes a field for podcast download quantity 940.

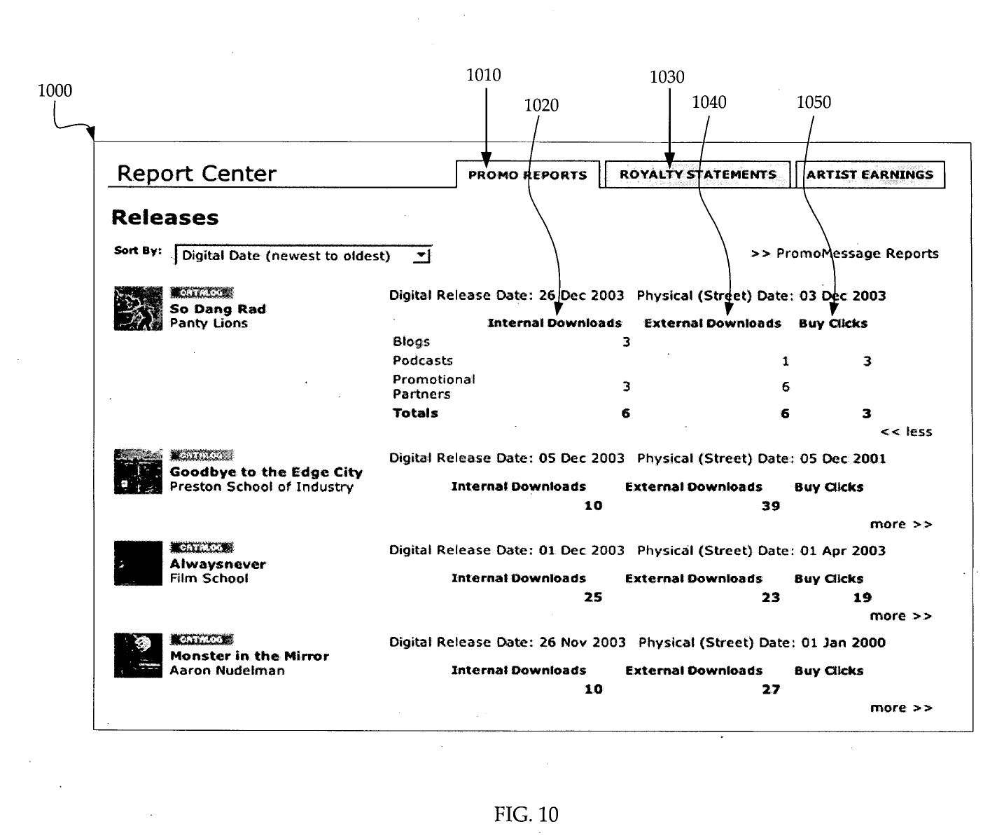

FIG. 10 is a screenshot of an exemplary rightsholder report. The exemplary rightsholder report 1000 includes promotional reports 1010, internal downloads 1020, royalty statements 1030, external downloads 1040, and buy clicks 1050.

In one exemplary embodiment, the exemplary rightsholder report 1000 includes information for the rightsholder regarding actions on the digital content promotion system 100 (FIG. 1). Such reports may include information under promotional reports 1010 about internal downloads 1020. Internal downloads 1020 may include information about those second parties such as bloggers and podcasters that have downloaded an item of digital content, such as a music track. Royalty statements 1030 may include information about the funds earned by a rightsholder due to the sales of related digital content. External downloads 1040 may include information about the activities of those who have viewed the blogs of the second party bloggers and have downloaded digital content from those blogs or who may have downloaded a particular podcast. Buy clicks 1050 includes information about those viewers or visitors to the second party web sites or applications that have also clicked on a purchase link.

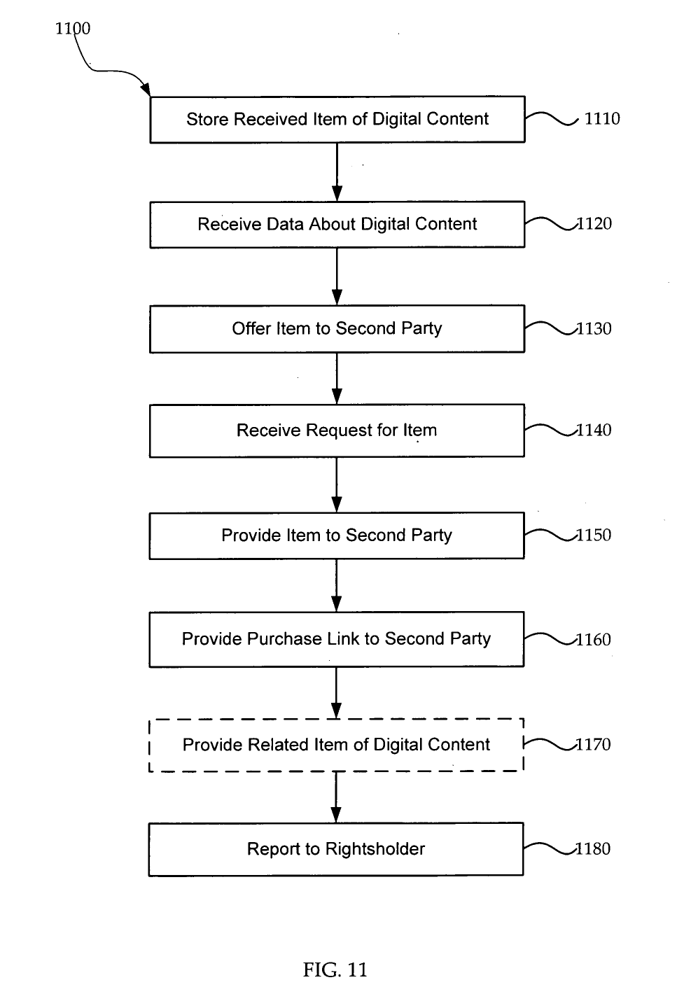

FIG. 11 is a flow chart of an exemplary method 1100 for digital content promotion.

At step 1110, an item of digital content received from a rightsholder is stored. According one exemplary method, the item of digital content may comprise a music track.

At step 1120, data about the item of digital content is received. According to various exemplary methods, the data about the item of digital content is received from a rightsholder for a particular item of digital content.

At step 1130, the item of digital content is offered to a second party. In one exemplary method, the item of digital content is offered to a blogger and/or podcaster.

At step 1140, a request for the item of digital content is received. According to various methods, the request is received from a second party such as a blogger or podcaster.

At step 1150, the item of digital content is provided to the second party. In one method, a link to the item of digital content is provided to the second party.

At step 1160, a purchase link for purchase of a related item of digital content is provided to the second party. According to one exemplary method, the purchase link is to an online retailer.

At optional step 1170, a related item of digital content is provided to an online retailer.

At step 1180, one or more of the above-specified steps may be reported to the rightsholder.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for digital content promotion comprising:
storing an item of digital content received from a rightsholder;
receiving data from the rightsholder about the item of digital content;
offering the item of digital content to a second party;
receiving a request from the second party for the item of digital content;
providing the item of digital content to the second party;
providing a purchase link to the second party for purchase of a related item of digital content; and
reporting to the rightsholder about use of the item of digital content.

2. The method of claim 1, wherein the second party is a promotional service.

3. The method of claim 1, wherein the second party features the item of digital content in connection with a computer application.

4. The method of claim 1, wherein the second party features the item of digital content in connection with a web site.

5. The method of claim 1, wherein the second party is a podcaster.

6. The method of claim 1, wherein the second party is a blogger.

7. The method of claim 1, wherein the second party is an online retailer.

8. The method of claim 1, wherein the item of digital content is offered to the second party as a link to the item of digital content.

9. The method of claim 1, wherein the item of digital content is provided to the second party as a link to the item of digital content.

10. The method of claim 1, wherein the second party incorporates the item of digital content within a podcast.

11. The method of claim 10, the method further comprising:
providing the podcast to a promotional service.

12. The method of claim 11, wherein the promotional service is maintained by a podcaster.

13. The method of claim 11, wherein the promotional service includes a web site.

14. The method of claim 11, wherein the promotional service includes a computer application.

15. The method of claim 11, the method further comprising:
reporting to the rightsholder a download of the podcast from the promotional service.

16. The method of claim 1, wherein the item of digital content includes metadata.

17. The method of claim 1, wherein the purchase link is to a third web site.

18. The method of claim 1, wherein the data received from the rightsholder includes permission from the rightsholder to offer the item of digital content to the second party.

19. The method of claim 1, the method further comprising:
reporting to the rightsholder an activation of a link triggering acquisition of the item of digital content.

20. The method of claim 17, the method further comprising:
providing a related item of digital content to the third web site.

21. The method of claim 17, wherein the third web site is an online retailer.

22. The method of claim 1, wherein the item of digital content is an audio file.

23. The method of claim 1, wherein the item of digital content is an audiovisual file.

24. The method of claim 1, wherein the item of digital content is an image file.

25. The method of claim 1, the method further comprising:
reporting to the rightsholder each time the purchase link is activated.

26. The method of claim 1, the method further comprising:
receiving from the rightsholder an identity corresponding to the second party to be offered the item of digital content.

27. The method of claim 1, the method further comprising:
providing the rightsholder with a choice of second parties to be offered the item of digital content.

28. The method of claim 1, the method further comprising:
providing the rightsholder with a mechanism to contact a second party.

29. The method of claim 1, wherein the use of the item of digital content is the providing of the item of digital content to the second party.

30. A system for digital content promotion comprising:
a digital content storage component configured to store an item of digital content received from a rightsholder;
a rightsholder data component coupled to the digital content storage component, the rightsholder data component configured to receive data from the rightsholder about the item of digital content;
a presentation engine in communication with the digital content storage and the rightsholder data components, the presentation engine configured to offer the item of digital content to a second party; and
a transmission module coupled to the presentation engine, the transmission module configured to receive over a network a request from the second party for the item of digital content and to provide the item of digital content to the second party.

31. A computer readable medium having embedded thereon a program, the program being executable by a processor for performing a method for digital content promotion, the method comprising:
storing an item of digital content received from a rightsholder;
receiving data from the rightsholder about the item of digital content;
offering the item of digital content to a second party;
receiving a request from the second party for the item of digital content; and
providing the item of digital content to the second party.
